(19) United States
(12) Patent Application Publication
(10) Pub. No.: US 2021/0286743 A1
(43) Pub. Date: Sep. 16, 2021

(54) MEMORY SYSTEM AND INFORMATION PROCESSING SYSTEM

(71) Applicant: KIOXIA CORPORATION, Tokyo (JP)

(72) Inventor: Naoki KIMURA, Ebina Kanagawa (JP)

(21) Appl. No.: 17/004,877

(22) Filed: Aug. 27, 2020

(30) Foreign Application Priority Data
Mar. 13, 2020 (JP) 2020-043813

(51) Int. Cl. G06F 13/16

(52) U.S. Cl. CPC G06F 13/1678

(57) ABSTRACT

A memory system includes a connector including a terminal, and a controller configured to perform a single-line bidirectional communication with a host via a signal line connected to the terminal. A format of a signal communicated via the single-line bidirectional communication includes a start pulse at a first level, a stop pulse at a second level, data pulses at the second level, and division pulses at the first level. The data pulses are after the start pulse but before the stop pulse. Each of the data pulses has a pulse width corresponding to a data value represented thereby. The division pulses have a uniform pulse width. A pulse width of the start pulse is greater than the uniform pulse width of the divisional pulses. A pulse width of the stop pulse is greater than any pulse width of the data pulses.

### CROSS-REFERENCE TO RELATED APPLICATION(S)

This application is based upon and claims the benefit of priority from Japanese Patent Application No. 2020-043813, filed on Mar. 13, 2020, the entire contents of which are incorporated herein by reference.

### FIELD

Embodiments described herein relate generally to a memory system and an information processing system.

### BACKGROUND

A memory system connectable to a host via a signal line communicates with the host via the signal line. It is desirable to simplify a connection configuration between the host and the memory system.

### BRIEF DESCRIPTION OF THE DRAWINGS

FIG. 1 is a diagram showing an external configuration of an information processing system including a memory system according to an embodiment.

FIG. 2 is a diagram showing a functional configuration of the information processing system including the memory system according to an embodiment.

FIG. 3 is a diagram showing a format of a signal communicated via single-line bidirectional communication in an embodiment.

FIG. 4 is a waveform diagram showing communication contents of a signal communicated via the single-line bidirectional communication in the embodiment.

FIG. 5 is a table showing communication contents of a signal communicated via the single-line bidirectional communication in the embodiment.

FIG. 6 is a waveform diagram to explain priority control of the single-line bidirectional communication in the embodiment.

FIG. 7 is a waveform diagram to explain an operation of the information processing system including the memory system according to the embodiment.

### DETAILED DESCRIPTION

Embodiments provide a memory system that can simplify a connection configuration between a host and the memory system.

In general, according to an embodiment, a memory system includes a connector having a terminal, and a controller configured to perform single-line bidirectional communication with a host via a signal line connected to the terminal. A signal communicated via the single-line bidirectional communication has a format that includes a start pulse, a stop pulse, a plurality of data pulses, and a plurality of division pulses. The start pulse is at a first level. The stop pulse is at a second level different from the first level. The plurality of data pulses is after the start pulse but before the stop pulse. Each of the data pulses is at the second level and has a pulse width corresponding to a data value represented thereby. The plurality of division pulses divides the plurality of data pulses. Each of the division pulses is at the first level. The division pulses have a uniform pulse width. A pulse width of the start pulse is greater than the uniform pulse width of the divisional pulses. A pulse width of the stop pulse is greater than any pulse width of the data pulses.

Hereinafter, a memory system according to example embodiments will be described with reference to the accompanying drawings. The present disclosure is not limited to the example embodiments.

### First Embodiment

The memory system according to the first embodiment is connectable to a host to via a signal line. The memory system communicates with the host via the signal line. The memory system may be, for example, a solid state drive (SSD), a hard disk drive, a hybrid hard disk drive, a USB memory, an SD card, or another type of readable/writable nonvolatile storage device. The host may be, for example, an information processing device such as a personal computer, a tester device, a manufacturing device, an imaging device such as a camera or a video camera, a mobile terminal such as a tablet computer or a smartphone, a game machine (game console), or a vehicle-mounted terminal such as a car navigation system.

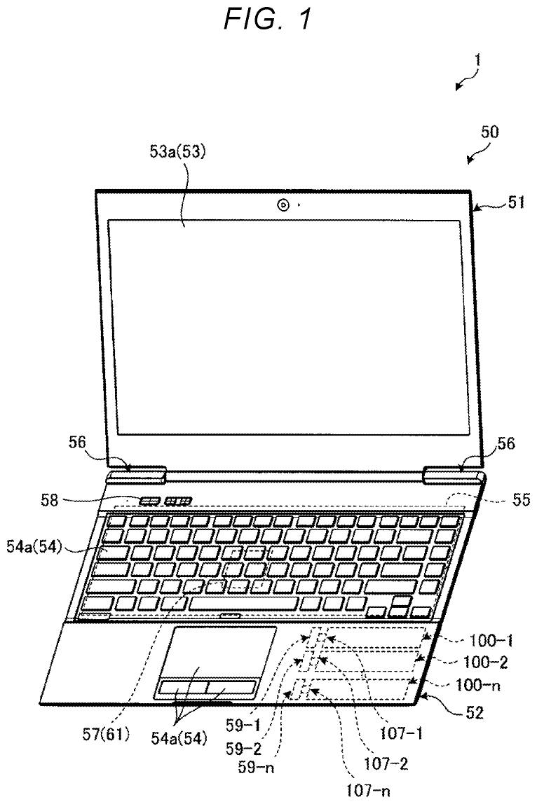

A configuration of an information processing system 1 including memory systems 100 and a host 50 according to the present embodiment will be described with reference to FIG. 1. FIG. 1 is a diagram showing an external configuration of the information processing system 1 including the memory systems 100 according to the present embodiment. The information processing system 1 according to the present embodiment includes the host 50 and the memory systems 100. FIG. 1 shows an external configuration when the host 50 is an information processing device such as a personal computer.

The host 50 includes housings 51 and 52, a display 53, an input device 54, connectors 59, and the like. The housing 51 and the housing 52 are rotatably connected to each other via a hinge portion 56. The display 53 is, for example, an LCD or OELD. The display 53 is housed in the housing 51 with a display surface 53a exposed. The input device 54 includes, for example, a keyboard, a pointing device, and a click button. The input device 54 is housed in the housing 52 with input units 54a exposed. The input device 54 includes a power button 58 disposed on the periphery of the keyboard.

The housing 52 houses a circuit board 55 and a plurality of memory systems 100 (individually designated as memory systems 100-1 to 100-n). A controller 61 including a central processing unit (CPU) 57 is mounted on the circuit board 55. The memory system 100 includes a connector 107. The connector 107 is connectable to a connector 59 of the host 50. The circuit board 55 and the memory systems 100 are electrically connected to each other via a wiring such as a flexible printed wiring board, the connector 59, and the connector 107. The connector 59 and the connector 107 transfer signals between the host 50 and the memory systems 100.

The memory system 100 receives a command from the host 50, via a terminal for high-speed serial communication and a signal line (high-speed communication path) as a standard interface (I/F), for example, such as SATA (Serial Advanced Technology Attachment) or PCIe® (Peripheral Component Interconnect Express), and returns to the host 50 a response according to the command. Further, the memory systems 100 may communicate with the host 50 via a terminal for low-speed serial communication such as UART (RS-232C) and a signal line instead of the high-speed communication path.

For example, if the power button 58 is pressed for a long time by a user when a part of an operation of the host 50 hangs up, the host 50 recognizes the operation as a user request of a forced power off. It is conceivable that the host 50 manages a power loss protection (PLP) processing including a data evacuation operation (or may be referred to as a data non-volatilization) in the memory system 100 in response to the user request of a forced power off.

Here, for example, a first technique in which a host manages a PLP processing of a memory system by using a plurality of terminals for high-speed serial communication and a plurality of signal lines is considered. According to the first technique, when the host detects a long press operation on a power button, the host transmits a first request indicating an instruction of the PLP processing to a first signal line via a first host terminal for high-speed serial communication. The memory system receives the first request via the first signal line and a first terminal for high-speed serial communication, and performs the PLP processing according to the first request. When the PLP processing is completed, the memory system transmits a first notification indicating a completion response of the PLP processing to the host via a second terminal for high-speed serial communication and a second signal line. The host receives the first notification via the second signal line and a second host terminal, and accordingly cuts off power supply to the memory system 100. This operation is the same as a normal shutdown operation.

Alternatively, when a part of a configuration of the memory system is in a standby state in which the power supply is cut off, communication via a plurality of terminals for high-speed serial communication and a plurality of signal lines may not be possible. Here, for example, a second technique in which a host manages a PLP processing of a memory system by using a plurality of terminals for low-speed serial communication and a plurality of signal lines is considered. According to the second technique, when the host detects a long press operation on a power button, the host transmits a second request indicating an instruction of the PLP processing to a third signal line via a third host terminal for low-speed serial communication. The memory system receives the second request from the host via the third signal line and a third terminal for low-speed serial communication. The memory system performs the PLP processing including a data evacuation operation in response to the second request. When the PLP processing is completed, the memory system transmits a second notification indicating a completion response of the PLP processing to the host via a fourth terminal for low-speed serial communication and a fourth signal line. The host receives the second notification via the fourth signal line and a fourth host terminal, and accordingly cuts off the power supply to the memory system.

The first technique and the second technique protect data to be stored in the memory system by cutting off the power supply to the memory system after completing non-volatilization of data, which is in the course of non-volatilization, in the memory system. In both the first technique and the second technique, separate terminals and signal lines are used for transmission and reception, and in addition, the host and the memory system are connected to each other in a one-to-one relationship. Therefore, when a plurality of memory systems are connected to a host, it is necessary to add signal lines, terminals, and interface circuits corresponding to the number of memory systems to the host side for each of transmission and reception. Accordingly, a connection configuration between the host and the memory systems may be complicated.

On the other hand, a third technique in which a host and a plurality of memory systems are wired or connected in a single-line manner to perform bidirectional communication can be considered. In the third technique, the connection configuration between the host and the memory systems can be simplified, but it may be difficult to secure the reliability of the single-line bidirectional communication.

For example, according to the third technique, a synchronization pulse signal is constantly transmitted from the host to a single signal line that connects the host and the plurality of memory systems. When there is a data signal to be transmitted, the host or the memory systems superimpose the data signal on the synchronization pulse signal and performs synchronous communication to transmit the data to the single signal line. In this case, a transmission signal in which the synchronization pulse signal and the data signal are superimposed on the single signal line is broadcast-transmitted to the host and the plurality of memory systems. At this time, a frequency of the synchronization pulse signal is maintained constant. When a deviation of edge timing between the synchronization pulse signal and the data signal is large, a pulse width of each pulse in the transmission signal may deviate greatly from an intended pulse width, and some data in the data signal may be lost or nonexistent data may be added. That is, depending on a size of the deviation of the edge timing between the synchronization pulse signal and the data signal, the host and the plurality of memory systems may not be able to correctly perform a reception processing, and the reliability of the single-line bidirectional communication may deteriorate.

To address the above-described issues, the memory system 100 according to the present embodiment communicates with the host 50 via the terminal for low-speed serial communication and the signal line, in addition to the high-speed communication path, such as SATA or PCIe. In the present embodiment, a specific format of a signal communicated via the single-line bidirectional communication between the host 50 and the plurality of memory systems 100-1 to 100-n via a single signal line is employed. Specifically, in the signal of the specific format, levels of a start pulse and a stop pulse are different from each other, and the start and stop pulses have pulse widths wider than a pulse width of a data pulse. According to such a format of a signal or a packet, simplification of a connection configuration between the host 50 and the memory systems 100 and improvement of the reliability of the single-line bidirectional communication can both be achieved.

Specifically, the host 50 and the plurality of memory systems 100 are wired or connected by the single signal line. The host 50 and the memory systems 100 can perform the bidirectional communication with each other via the single signal line. Accordingly, since the host 50 and the plurality of memory systems 100 are connectable in a one-to-many relationship, a connection configuration on the host 50 side can be shared by the plurality of memory systems 100, and the connection configuration between the host 50 and the memory systems 100 can be simplified. Further, the format of a signal communicated via the single-line bidirectional communication includes, between the start pulse having a first level (for example, L level) and the stop pulse having a second level (for example, H level or high impedance), a plurality of data pulses having the second level and a plurality of division pulses having the first level that are alternately arranged a plurality of times. At this time, the pulse width of the start pulse is wider than a pulse width of each division pulse. Further, the pulse width of the stop pulse is wider than the pulse width of each data pulse. The pulse width of the data pulse includes two types of pulse widths according to data values, and both are equal to or less than the pulse width of the stop pulse. Here, each of these pulse widths corresponds to a width of time period of the first level or time period of the second level. Accordingly, one of the host 50 and the memory system 100, which is a reception side device, observes a level on the single signal line, and detects the pulse width by using a counter or the like, so that the host 50 or the memory system 100 can recognize the start pulse, the data pulses, the division pulses, and the stop pulse transmitted from the other one of the host 50 or the memory system 100, which is a transmission side device (may be referred to as a “sender”). Further, the pulse width of the data pulse is variable for corresponding to different data values. The pulse width of the data pulse varies within a range between the pulse width of the start pulse and the pulse width of the stop pulse. Accordingly, a total pulse width of a data portion varies, but the data portion can be identified by recognizing the start pulse and the division pulses and counting the number of any pulse. In this way, according to the present embodiment, since the single-line bidirectional communication can be performed asynchronously between the host 50 and the memory systems 100, the host 50 and the memory systems 100 can easily achieve the correct reception processing. Therefore, the connection configuration between the host 50 and the memory systems 100 can be simplified, and the reliability of the single-line bidirectional communication can be improved. In the present embodiment, each pulse includes a first edge portion of transitioning from the first level to the second level, a time period of the second level, and a second edge portion of transitioning from the second level to the first level. Each pulse may include a first edge portion of transitioning from the second level to the first level, a time period of the first level, and a second edge portion of transitioning from the first level to the second level. Therefore, in the consecutive two pulses, a second edge portion of a front pulse and a first edge portion of a behind pulse are the same edge portion.

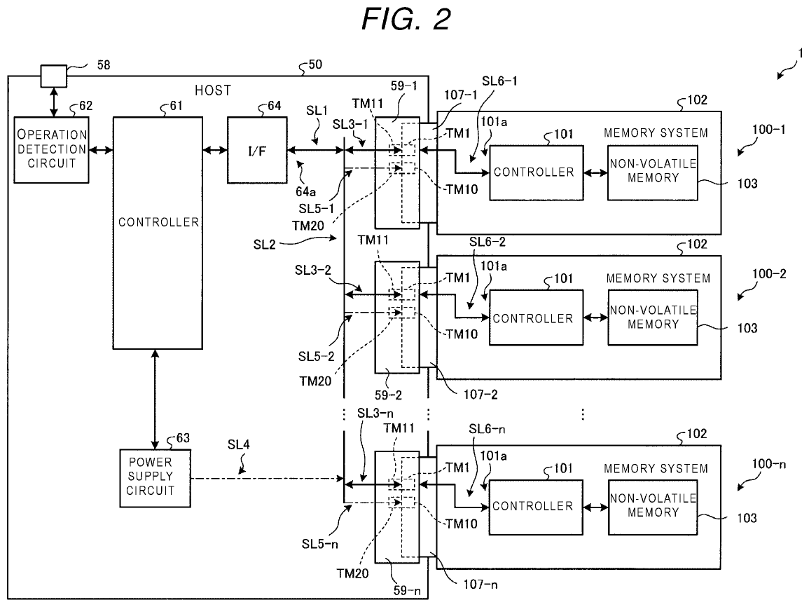

More specifically, the information processing system 1 including the plurality of memory systems 100 is configured as shown in FIG. 2. FIG. 2 is a diagram showing a functional configuration of the information processing system 1 including the plurality of memory systems 100. The information processing system 1 includes the host 50 and the plurality of memory systems 100.

The host 50 includes an interface circuit 64, the controller 61, an operation detection circuit 62, a power supply circuit 63, and the connectors 59. The interface circuit 64, the controller 61, the operation detection circuit 62, and the power supply circuit 63 are connected to each other via a bus. The controller 61 is implemented by, for example, a CPU or an MPU, and controls each unit of the host 50. The operation detection circuit 62 outputs a detection result to the controller 61 when detecting a pressing operation on the power button 58, for example. The interface circuit 64 controls communication between the controller 61 and the plurality of memory systems 100 via the connectors 59. Under the control of the controller 61, the power supply circuit 63 starts, continues, or cuts off the power supply to the plurality of memory systems 100. The connector 59 is disposed on the motherboard or an end portion of the host 50, and can be configured as a socket corresponding to an edge connector.

Each memory system 100 is a memory device such as a solid state drive (SSD), and can function as an external storage medium for the host 50. Each memory system 100 is, for example, a relatively small module, and an example of an external dimension thereof is 22 mm×80 mm. A size of each memory system 100 is not limited to the above, and a configuration of the present embodiment can be appropriately applied to various sizes.

The memory system 100 includes a controller 101, a non-volatile memory 103, a substrate 102, and the connector 107. The controller 101 controls each unit of the memory system 100. The non-volatile memory 103 is, for example, a NAND flash memory, is implemented as one or more memory packages in which one or more memory chips are housed, and stores data in a non-volatile manner. The memory chip includes a memory cell array in which a plurality of memory cells are arranged in a matrix. Each of the memory cells may be capable of performing multi-valued storage by using a plurality of pages (for example, upper page and lower page). In the memory chip, data is erased in a block unit, and data is written and data is read for each page. The block includes a plurality of pages. The connector 107 is disposed on an end portion of the substrate 102 and can be configured as the edge connector.

The connector 107 (for example, an edge connector) and the connector 59 (for example, a socket) have a shape according to a form factor standard (for example, M.2 form factor). A notch is formed in the connector 107 at a position displaced from a center position along a lateral direction of the substrate 102. The position where the notch is formed in the connector 107 may be, for example, a position of an “M key” in the M.2 form factor, or a position of a “B & M key” in the M.2 form factor. A protrusion is provided on the connector 59 at a position corresponding to the notch of the connector 107.

The notch and the protrusion are configured to engage with each other when the connector 107 is connected to the connector 59. Accordingly, a desired form factor (for example, the M.2 form factor) is selected from a plurality of types of form factors for the connector 59 of the host 50. Further, for the connector 107 of the memory system 100, a desired type (for example, a type M or type B+M corresponding to the “M key”) connector is selected from a plurality of types of connectors according to the selected desired form factor standard. Accordingly, it is possible to prevent the memory system 100 from being attached to the host 50 upside down.

The connector 107 and the connector 59 are provided with a plurality of terminals corresponding to each other. For example, the connector 107 is provided with a plurality of pins, and the connector 59 is provided with a plurality of contacts corresponding to the plurality of pins. When the connector 107 is connected to the connector 59, each terminal (each pin) of the connector 107 comes into contact with and is electrically connected to the corresponding terminal (contact) of the connector 59. Accordingly, the host 50 and the memory systems 100 can be communicatively connected.

When the connector 107 of the memory system 100 is connected to the connector 59 of the host 50, the controller 61 of the host 50 can communicate with the controller 101 of the memory system 100 via the interface circuit 64, the connector 59, and the connector 107. The controller 61 can transmit command data or the like to the controller 101 via the interface circuit 64, the connector 59, and the connector 107. The controller 101 writes data to the non-volatile memory 103 or reads data from the non-volatile memory 103 according to the command, and in response thereto, transmits response data or the like to the controller 61. The controller 61 receives the response data or the like from the controller 101 via the connector 107, the connector 59, and the interface circuit 64.

Here, a terminal TM11 of the connector 59 and a terminal TM1 of the connector 107 can be assigned for single-line bidirectional communication. The pull-up resistor and an open drain type transmission and reception circuit may be connected to a terminal 64a of the interface circuit 64 or a terminal 101a of the controller 101. Further, the pull-up resistor and the open drain type transmission and reception circuit may be connected between the terminal TM1 and the controller 101. Accordingly, the host 50 and the plurality of memory systems 100 can be wired or connected via a single signal line.

A terminal TM20 of the connector 59 and a terminal TM10 of the connector 107 may be separately assigned to power supply terminals. Each memory system 100 may be supplied with power from the power supply circuit 63 of the host 50 via power supply lines SL4 and SL5 and the terminals TM20 and TM10.

The controller 101 includes the terminal 101a electrically connected to the terminal TM1 of the connector 107 via a signal line SL6. The connectors 59-1 to 59-n each include terminals TM11 and TM20 which are respectively electrically connected to the terminals TM1 and TM10, when the connectors 107-1 to 107-n are connected thereto. The terminals TM11 of the connectors 59-1 to 59-n are respectively connected to signal lines SL3-1 to SL3-n. The signal lines SL3-1 to SL3-n are separately connected to a signal line SL1 via a signal line SL2. The signal line SL1 is connected to the terminal 64a of the interface circuit 64. That is, the terminal 64a of the interface circuit 64 and the terminal TM1 of each connector 59 are equivalently electrically connected via the signal lines SL1, SL2, and SL3. That is, the terminal 64a of the interface circuit 64 and the terminal 101a of the controller 101 of each memory system 100 are equivalently electrically connected via one signal line including the signal lines SL1, SL2, SL3, and SL6 (hereinafter, referred to as signal line SL #). The controller 101 of each memory system 100 can perform single-line bidirectional communication with the host 50 via one signal line SL # connected to the terminal 64a.

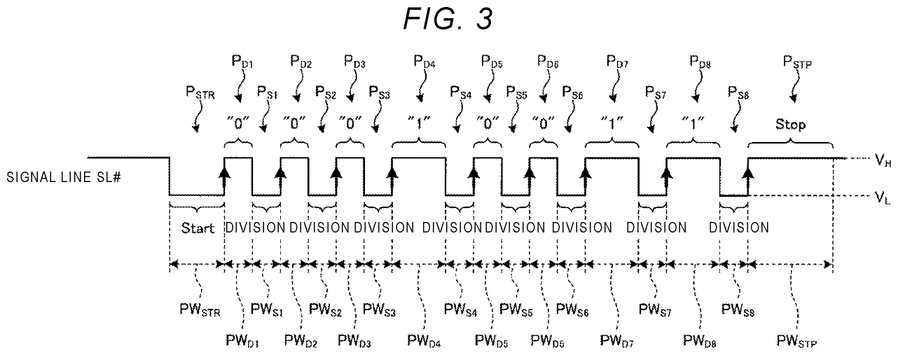

At this time, a signal format of the single-line bidirectional communication is as shown in FIG. 3, for example. FIG. 3 is a waveform diagram showing the format of a signal communicated via the single-line bidirectional communication. In FIG. 3, a waveform of a signal transmitted via the signal line SL # is shown, and a vertical axis indicates a voltage of the signal line SL # and a horizontal axis indicates a time.

The format of a signal communicated via the single-line bidirectional communication includes data pulses P_{D1} to P_{D8} and division pulses P_{S1} to P_{S8} that are alternately arranged a plurality of times between a start pulse P_{STR} and a stop pulse P_{STP}. The division pulses P_{S1} to P_{S8} thereby divide the data pulses P_{D1} to P_{D8}. In a case of FIG. 3, eight data pulses P_{D1} to P_{D8} are arranged between the start pulse P_{STR} and the stop pulse P_{STP}, and the eight data pulses P_{D1} to P_{D8} indicate 8-bit data.

At this time, the start pulse P_{STR} and the division pulses P_{S1} to P_{S8} each have a low level V_{L}, and the data pulses P_{D1} to P_{D8} and the stop pulse P_{STP} each have a high level V_{H}.

Further, a pulse width PW_{STR} of the start pulse P_{STR} is wider than each of pulse widths PW_{S1} to PW_{S8} of the division pulses P_{S1} to P_{S8}. For example, when a reference length is T, the pulse width PW_{STR} of the start pulse P_{STR}=2T and each of the pulse widths PW_{S1} to PW_{S8} of the division pulses P_{S1} to P_{S8}=1T.

Each of the pulse widths PW_{D1} to PW_{D8} of the data pulses P_{D1} to P_{D8} is less than or equal to the pulse width PW_{STP} of the stop pulse P_{STP}. The pulse widths PW_{D1} to PW_{D8} of the data pulses P_{D1} to P_{D8} are variable according to a data value within a range that is less than or equal to the pulse width PW_{STP} of the stop pulse P_{STP}. The pulse widths PW_{D1} to PW_{D3}, PW_{D5}, and PW_{D6} of the data pulses P_{D1} to P_{D3}, P_{D5}, and P_{D6} each have a first time width corresponding to a data value “0”. The pulse widths PW_{D4}, PW_{D7}, PW_{D8} of the data pulses P_{D4}, P_{D7}, P_{D8} each have a second time width corresponding to a data value “1”. The second time width is a time width different from the first time width, and is, for example, a time width larger than the first time width.

For example, when the reference length is T, the pulse widths PW_{D1} to PW_{D3}, PW_{D5}, and PW_{D6} of the data pulses P_{D1} to P_{D3}, P_{D5}, and P_{D6} each having the data value “0”=1T, and the pulse widths PW_{D4}, PW_{D7}, and PW_{D8} of the data pulses P_{D4}, P_{D7}, and P_{D8} each having the data value “1”=2T.

The pulse width PW_{STP} of the stop pulse P_{STP} is wider than the pulse widths PW_{D4}, PW_{D7}, and PW_{D8} of the data pulses P_{D4}, P_{D7}, and P_{D8} each having the data value “1”. For example, when the reference length is T, the pulse width PW_{STP} of the stop pulse P_{STP}=2T.

Accordingly, one of the host 50 and the memory system 100, which is the reception side device, observes the level on the single signal line by using a comparator or the like, and detects the pulse width by using a counter or the like, so that the host 50 or the memory system 100 can recognize the start pulse P_{STR}, the data pulses P_{D1} to P_{D8}, the division pulses P_{S1} to P_{S8}, and the stop pulse P_{STP} transmitted from the other one of the host 50 and the memory system 100, which is the transmission side device. Further, by detecting the pulse widths of the data pulses P_{D1} to P_{D8} by using a counter or the like, it is possible to recognize a content of data (hereinafter, also referred to as communication content) communicated by the single-line bidirectional communication. In the case of FIG. 3, an 8-bit communication content can be recognized by detecting the pulse widths PW_{D1} to PW_{D8} of the eight data pulses P_{D1} to P_{D8}.

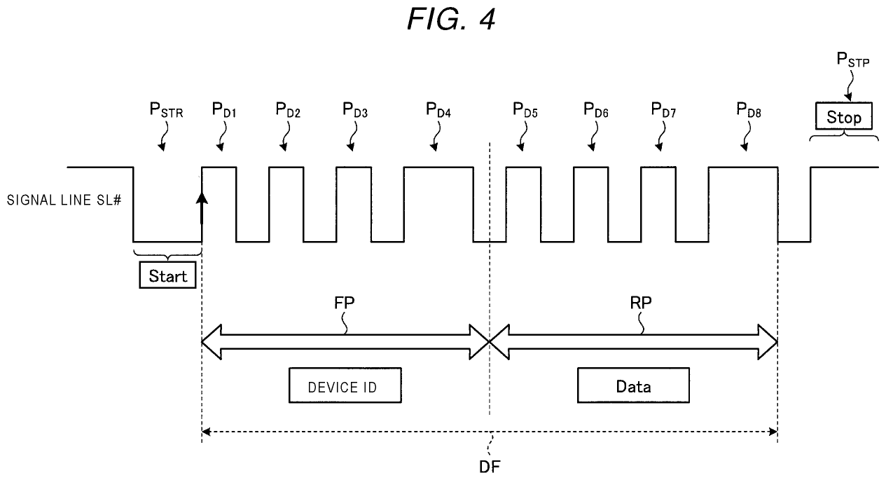

For example, the communication content of the single-line bidirectional communication is as shown in FIG. 4. FIG. 4 is a waveform diagram showing the communication content of a signal communicated via the single-line bidirectional communication.

When a data portion between the start pulse P_{STR} and the stop pulse P_{STP} is called a data frame DF, the data frame DF includes the eight data pulses P_{D1} to P_{D8} and indicates 8-bit data. The data frame DF is divided into a front half portion FP and a rear half portion RP, and, for example, four data pulses P_{D1} to P_{D4} are assigned to the front half portion FP, and four data pulses P_{D5} to P_{D8} are assigned to the rear half portion RP. Here, a communication content of the front half portion FP is a device ID for identifying the host 50 or the memory system 100, and a communication content of the rear half portion RP is data (hereinafter, also referred to as communication data) indicating a command or notification. Accordingly, the host 50 or the memory system 100, which is the reception side device, observes the level on the single signal line by using a comparator or the like, and detects the pulse width by using a counter or the like, so that the host 50 or the memory system 100 can recognize which one of the host 50 and the memory system 100 transmits an observed pulse, and can confirm the communication data.

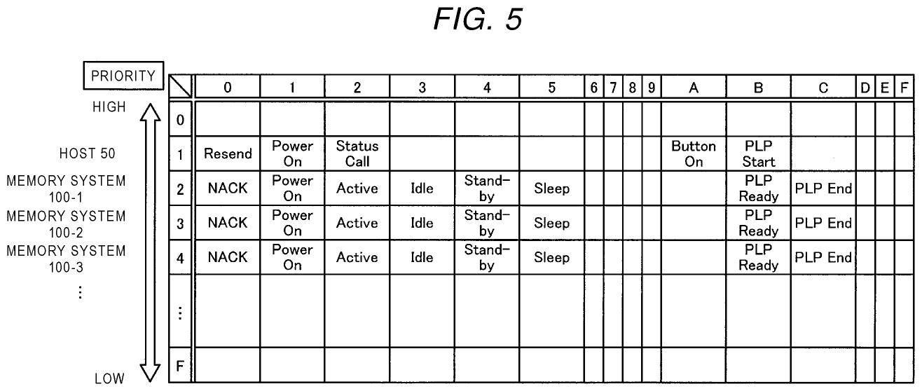

A combination of the device ID and the communication data is, for example, as shown in a table shown in FIG. 5. That is, in the single-line bidirectional communication, a command table is defined as communication data before communication, and a response to a command (request) can also be defined before communication. FIG. 5 is a diagram showing the communication data of the single-line bidirectional communication. In the table of FIG. 5, a vertical column at a left side indicates the 8-bit device ID in hexadecimal display, and a horizontal column at an upper side indicates the 8-bit communication data in hexadecimal display. In FIG. 5, the device ID “1”, the device ID “2”, the device ID “3”, and the device ID “4” are assigned to the host 50, the memory system 100-1, the memory system 100-2, and the memory system 100-3, respectively. In the single-line bidirectional communication, exclusive communication control is performed. That is, in a period in which one of the host 50 and the memory system 100 uses a single signal line, communication control is performed so that the other one of the host 50 and the memory system 100 cannot use the single signal line. Therefore, a communication priority can be set between the host 50 and the plurality of memory systems 100-1 to 100-n. For example, the communication priority may be higher as the device ID is smaller. For communication data of the host 50, data “0” indicates a “Resend” request, . . . data “B” indicates a “PLP Start” request. For communication data of the memory systems 100-1 to 100-3, data “0” indicates a “NACK” response, . . . data “C” indicates a “PLP End” notification. Each communication data will be described later.

At this time, when signals are transmitted between the host 50 and the plurality of memory systems 100 on the single signal line SL # almost at the same time, a communication collision may occur on the single signal line SL #. The host 50 or the memory system 100, which is the transmission side device, grasps the communication content (that is, the combination of the device ID and the communication data) to be transmitted therefrom. Therefore, the controller 61 of the host 50 or the controller 101 of the memory system 100 observes a level of the single signal line SL #, and when the level does not reach a level expected at an expected time according to the communication content, the controller 61 of the host 50 or the controller 101 of the memory system 100 can recognize that a communication collision with the other device (the host 50 or the memory system 100) occurs. Accordingly, the host 50 or the memory system 100, which is the transmission side device, can retransmit the communication content.

For example, the controller 61 or the controller 101 of the transmission side device stops transmission of the start pulse P_{STR} when a time corresponding to the pulse width PW_{STR} elapses after transmitting the start pulse P_{STR} having the L level to the signal line SL #. When the level of the signal line SL # does not change from the L level to the H level at this timing, the controller 61 or the controller 101 recognizes that a communication collision with the other device occurs. In response thereto, the controller 61 or the controller 101 waits until the signal line SL # reaches the H level, and when the time corresponding to the pulse width PW_{STP} elapses from when the signal line SL # changes to the H level, the controller 61 or the controller 101 determines that communication with the other device is not being performed. In response thereto, the controller 61 or the controller 101 of the transmission side device can retransmit the start pulse P_{STR} to the signal line SL #, and can subsequently transmit the communication content and the stop pulse P_{STP}.

However, when there is a slight deviation of the timing of transmission to the single signal line SL # due to a plurality of devices, it may be difficult to detect, based on a deviation of a change timing from the start pulse P_{STR} having the L level to the first data pulse P_{D1} having the H level, that a communication collision occurs on the single signal line SL #.

Therefore, in the single-line bidirectional communication according to the present embodiment, the priority control is performed. Specifically, by adjusting a wait time before transmission of the start pulse P_{STR} according to the priority, the deviation of the change timing from the start pulse P_{STR} to the first data pulse P_{D1} is detected. For example, when the host 50, the memory system 100-1, and the memory system 100-2 have higher priority in the above order, and wait times of the host 50, the memory system 100-1, and the memory system 100-2 are respectively T_{W0}, T_{W1}, and T_{W2}, the following Expression 1 is established.

T_{W0}<T_{W1}<T_{W2} Expression 1

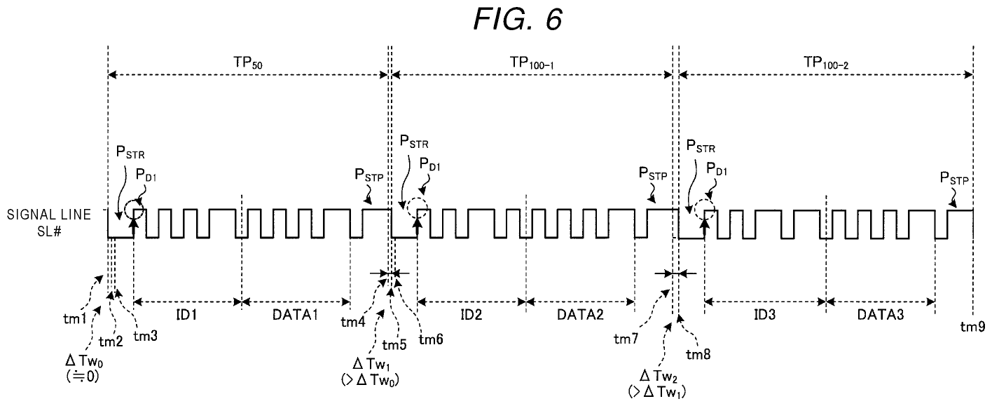

For example, as shown in FIG. 6, the priority control of the single-line bidirectional communication is performed. FIG. 6 is a waveform diagram to explain an example of the priority control of the single-line bidirectional communication, and is a waveform diagram showing a temporal change of a voltage level of the signal line SL #.

Here, a case where the host 50, the memory system 100-1, and the memory system 100-2 try to simultaneously start transmission of a signal is considered. At this time, at a time when trying to start the transmission of the signal, each of the host 50, the memory system 100-1, and the memory system 100-2 recognizes that preparation of data transmission is completed and the signal line SL is at the H level. For example, when T_{W0}≈0, at a time tm1, the host 50 immediately transmits the start pulse P_{STR} having the L level to the signal line SL1 during the wait time T_{W0} (≈0). On the other hand, the memory system 100-1 tries to start transmission of a signal at a time tm2 when the wait time T_{W1} (>T_{W0}) elapses after the time tm1. However, since the signal line SL # (SL6) already changed to the L level, the memory system 100-1 waits and postpones signal transmission while another device (here, the host 50) is transmitting a signal. Further, the memory system 100-2 tries to start transmission of a signal at a time tm3 when the wait time T_{W2} (>T_{W1}) elapses after the time tm1. However, since the signal line SL # (SL6) has already changed to the L level, the memory system 100-2 waits and postpones signal transmission while another device (here, the host 50) is transmitting a signal.

At a time tm4, since the H level continues with the pulse width PW_{STP} of the stop pulse P_{STP} after the 8-bit data (communication content) is transmitted, each of the memory system 100-1 and the memory system 100-2 recognizes that transmission of a signal from another device (here, the host 50) is completed, and tries to start transmission of a signal. The memory system 100-1 transmits the start pulse P_{STR} to the signal line SL # at a time tm5 when the wait time T_{W1} (>T_{W0}) elapses from the time tm4. On the other hand, the memory system 100-2 tries to start transmission of a signal at a time tm6 when the wait time T_{W2} (>T_{W1}) elapses from the time tm4. However, since the signal line SL # has already changed to the L level, the memory system 100-2 waits while and postpones signal transmission another device (here, the memory system 100-1) is transmitting a signal.

At a time tm7, since the H level continues with the pulse width PW_{STP} of the stop pulse P_{STP} after the 8-bit data (communication content) is transmitted, the memory system 100-2 recognizes that transmission of a signal from another device (here, the memory system 100-1) is completed, and tries to start transmission of a signal. The memory system 100-2 transmits the start pulse P_{STR} to the signal line SL # at a time tm8 when the wait time T_{W2} (>T_{W1}) elapses from the time tm7.

At a time tm9, the H level continues with the pulse width PW_{STP} of the stop pulse P_{STP}, and the transmission of the signal from the memory system 100-2 is completed.

As shown in FIG. 6, transmission of a signal from the host 50 to the signal line SL # (SL1) is performed during a period TP₅₀ from the time tm1 to the time tm4. Transmission of a signal from the memory system 100-1 to the signal line SL # (SL6) is performed during a period TP₁₀₀₋₁ from the time tm5 to the time tm7. Transmission of a signal from the memory system 100-2 to the signal line SL # (SL6) is performed during a period TP₁₀₀₋₂ from the time tm8 to the time tm9. That is, the transmission of the signal from the host 50, the memory system 100-1, and the memory system 100-2 can be controlled to be performed in order of priority.

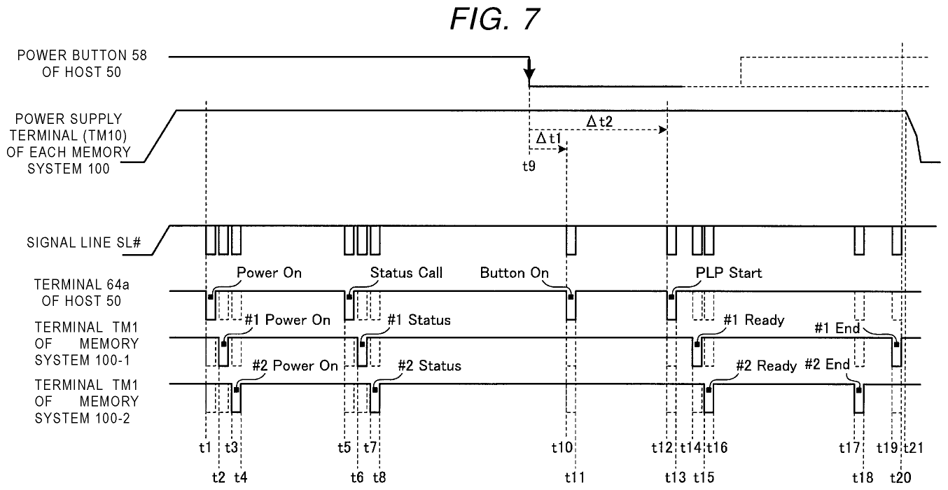

Further, the single-line bidirectional communication between the host 50 and the plurality of memory systems 100-1 and 100-2 can be performed as shown in FIG. 7. FIG. 7 is a waveform diagram to explain an operation of the information processing system 1 including the memory systems 100.

Before time t1, the power supply circuit 63 of the host 50 supplies power to the memory systems 100-1 and 100-2 via the power supply line SL4 and the terminals TM20 and TM10. After being supplied with power, the memory systems 100-1 and 100-2 observe the levels and the pulse widths of the signal lines SL # (SL6) connected to the respective terminals 101a thereof.

At the time t1, after the wait time T_{W0} (≈0) elapses since preparation for transmission of a signal is completed, the host 50 transmits a “Power On” request to the signal line SL # (SL1) via the terminal 64a of the interface circuit 64 by broadcast.

For example, by observing the signal line SL # (SL6), the memory system 100-1 detects that the H level continues with the pulse width PW_{STP} of the stop pulse P_{STP} or more after the 8-bit data (communication content) indicating the “Power On” request from the host 50 is transmitted, and recognizes that the transmission of the request is completed. In response to the recognition, the memory system 100-1 prepares to transmit a response to the “Power On”. Similarly, the memory system 100-2 recognizes, by observing the signal line SL, that the transmission of the “Power On” request from the host 50 is completed, and in response to the recognition, the memory system 100-2 prepares to transmit a response to the “Power On”.

The memory system 100-1 detects the stop pulse P_{STP} having the pulse width PW_{STP}, and at a time t2 when the wait time T_{W1} (>T_{W0}) elapses since the preparation for the transmission of the response is completed, transmits the response to the “Power On” to the terminal 101a. The host 50 and the memory system 100-2 detect the response to the “Power On” from the memory system 100-1 by observing the level and the pulse width of the signal line SL # therein.

The memory system 100-2 recognizes, by observing the signal line SL # (SL6), that the transmission of the response to the “Power On” from the memory system 100-1 is completed. The memory system 100-2 detects the stop pulse P_{STP} having the pulse width PW_{STP}, and at a time t3 when the wait time T_{W2} (>T_{W1}) elapses since the preparation for the transmission of the response is completed, transmits the response to the “Power On” to the terminal 101a. The host 50 and the memory system 100-1 detect the response to the “Power On” from the memory system 100-2 by observing the level and the pulse width of the signal line SL # therein.

At a time t4, the level of the signal line SL # returns to the H level, and then is maintained at the H level. That is, after the time t4, none of the host 50, the memory system 100-1, and the memory system 100-2 transmits a signal.

At a time t5, after the wait time T_{W0} (≈0) elapses since preparation for transmission of a signal is completed, the host 50 transmits a “Status Call” request to the signal line SL # via the terminal 64a of the interface circuit 64 by broadcast.

For example, by observing the signal line SL #, the memory system 100-1 detects that the H level continues with the pulse width PW_{STP} of the stop pulse P_{STP} or more after the 8-bit data (communication content) indicating the “Status Call” request from the host 50 is transmitted, and recognizes that the transmission of the request is completed. In response to the recognition, the memory system 100-1 prepares to transmit a response to the “Status Call”. Similarly, the memory system 100-2 recognizes, by observing the signal line SL #, that the transmission of the “Status Call” request from the host 50 is completed, and in response to the recognition, the memory system 100-2 prepares to transmit a response to the “Status Call”.

The memory system 100-1 detects the stop pulse P_{STP} having the pulse width PW_{STP}, and at a time t6 when the wait time T_{W1} elapses since the preparation for the transmission of the response is completed, transmits a status (for example, “Active”, “Idle”, “Stand-by”, “Sleep”, or the like) of the memory system 100-1 to the terminal 101a. The host 50 and the memory system 100-2 recognize the status of the memory system 100-1 by observing the level and the pulse width of the signal line SL # therein.

The memory system 100-2 recognizes, by observing the signal line SL #, that the transmission of the status from the memory system 100-1 is completed. The memory system 100-2 detects the stop pulse P_{STP} having the pulse width PW_{STP}, and at a time t7 when the wait time T_{W2} elapses since the preparation for the transmission of the response is completed, transmits a status (for example, “Active”, “Idle”, “Stand-by”, “Sleep”, or the like) of the memory system 100-2 to the terminal 101a. The host 50 and the memory system 100-1 recognize the status of the memory system 100-2 by observing the level and the pulse width of the signal line SL # therein.

At a time t8, the level of the signal line SL # returns to the H level, and then is maintained at the H level. That is, after the time t8, none of the host 50, the memory system 100-1, and the memory system 100-2 transmits a signal.

At a time t9, the host 50 recognizes, via the operation detection circuit 62, that the pressing operation on the power button 58 has started.

At a time t10 when a time Δt1 elapses from the time t9, the host 50 recognizes that the power button 58 may be pressed for a long time (for example, continuously for a time Δt2 (>Δt1)) in response to the pressing operation on the power button 58 continuing for the time Δt1. Therefore, the host 50 transmits a “Button On” notification to the signal line SL # via the terminal 64a of the interface circuit 64 by broadcast. In response thereto, by observing the level and the pulse width of the signal line SL #, the memory system 100-1 and the memory system 100-2 detect the “Button On” notification from the host 50, recognize that the button may be pressed for a long time and forced power-off may be requested, and make preliminary preparation for a PLP processing. An example is described in which the memory systems 100-1 and 100-2 do not particularly transmit a response to the detection of the “Button On” notification from the host 50. Alternatively, the memory systems 100-1 and 100-2 may transmit a response.

At a time t11, the level of the signal line SL # returns to the H level, and then is maintained at the H level. That is, after the time t11, none of the host 50, the memory system 100-1, and the memory system 100-2 transmits a signal.

At a time t12 when the time Δt2 elapses from the time t9, the controller 61 of the host 50 recognizes that the power button 58 is pressed for a long time and the forced power-off is requested in response to the pressing operation on the power button 58 continuing for the time Δt2. Therefore, the controller 61 of the host 50 transmits a “PLP Start” request to the signal line SL # via the terminal 64a of the interface circuit 64 by broadcast. In response thereto, by observing the level and the pulse width of the signal line SL #, the memory system 100-1 and the memory system 100-2 detect the “PLP Start” request from the host 50, recognize that the button is pressed for a long time and forced power-off is requested, and prepare to start the PLP processing including a data evacuation operation.

At a time t13, the level of the signal line SL # returns to the H level, and then is maintained at the H level.

After the preparation for starting the PLP processing is completed, at a time t14 when the wait time T_{W1} elapses since transmission of a signal indicating the start of the PLP processing is tried to be started, the memory system 100-1 transmits a “PLP Ready” notification to the signal line SL # via the terminal 101a. By observing the level and the pulse width of the signal line SL # therein, the host 50 and the memory system 100-2 detect the “PLP Ready” notification from the memory system 100-1 and recognize that the PLP processing is started by the memory system 100-1. The memory system 100-1 transmits the “PLP Ready” notification after or before starting the PLP processing.

The memory system 100-2 recognizes, by observing the signal line SL #, that the transmission of the “PLP Ready” notification from the memory system 100-1 is completed.

Here, the preparation for starting the PLP processing is completed by the memory system 100-2. At a time t15 when the wait time T_{W2} elapses from completion of the transmission of the “PLP Ready” notification from the memory system 100-1 since transmission of a signal indicating the start of the PLP processing is tried to be started, the memory system 100-2 transmits a “PLP Ready” notification to the terminal 101a. By observing the level and the pulse width of the signal line SL # therein, the host 50 and the memory system 100-1 detect the “PLP Ready” notification from the memory system 100-2 and recognize that the PLP processing is started by the memory system 100-2. The memory system 100-2 transmits the “PLP Ready” notification after or before starting the PLP processing.

At time t16, the level of the signal line SL # returns to the H level, and then is maintained at the H level. After time t16, the memory system 100-1 and the memory system 100-2 complete the PLP processing. Here, it is assumed that the memory system 100-2 completes the PLP processing earlier than the memory system 100-1.

At time t17 when the wait time T_{W2} elapses since transmission of a signal indicating the completion of the PLP processing is tried to be started, the memory system 100-2 transmits a “PLP End” notification to the terminal 101a. By observing the level and the pulse width of the signal line SL # therein, the host 50 and the memory system 100-1 detect the “PLP End” notification from the memory system 100-2 and recognize that the PLP processing is completed by the memory system 100-2.

At time t18, the level of the signal line SL # returns to the H level, and then is maintained at the H level.

At time t19 when the wait time T_{W1} elapses since transmission of a signal indicating the completion of the PLP processing is tried to be started, the memory system 100-1 transmits a “PLP End” notification to the terminal 101a. By observing the level and the pulse width of the signal line SL # therein, the host 50 and the memory system 100-2 detect the “PLP End” notification from the memory system 100-1 and recognize that the PLP processing is completed by the memory system 100-1.

At time t20, the level of the signal line SL # returns to the H level, and then is maintained at the H level. That is, after the time t20, none of the host 50, the memory system 100-1, and the memory system 100-2 transmits a signal. The host 50 observes the level and the pulse width of the signal line SL #, if the H level continues for the pulse width PW_{STP} of the stop pulse P_{STP} or more after receiving the 8-bit data, the host 50 recognizes that the transmission of the “PLP End” notification from the memory system 100-1 is completed.

At time t21, in response to the completion of the PLP processing of each of the memory systems 100-1 and 100-2, the power supply circuit 63 of the host 50 stops the supply of power to the memory systems 100-1 and 100-2 via the power supply lines and the terminals TM20 and TM10. Accordingly, the power supply can be cut off after the PLP processing including data evacuation in each of the memory systems 100-1 and 100-2 is completed, and the data in each of the memory systems 100-1 and 100-2 can be reliably protected when a user requests forced power-off.

As described above, in the present embodiment, in the format of the signal communicated via the single-line bidirectional communication between the host 50 and the plurality of memory systems 100 via the single signal line SL #, a width of division pulse that divides a plurality of data pulses is set to a fixed length, so that data pulses having different pulse widths are arranged according to a data value following the division pulse, and levels of a start pulse and a stop pulse are made different from each other and a pulse width of each pulse is made wider than the pulse width of the data pulse. Accordingly, it is possible to implement communication using a bidirectional data bus signal in a simple format that can be achieved by an inexpensive microcomputer (microcontroller) or the like having a low processing speed (a low reference clock frequency). A width of each of the division pulses may differ from a width of the start pulse having the same level of that of the division pulse, and may become a width during which the number of sampling based on the reference clock is constant. By connecting the host 50 and the plurality of memory systems 100 with such a communication specification, it is possible to perform one-to-many control and status confirmation with a single line. Therefore, the simplification of the connection configuration between the host 50 and the memory systems 100 and the improvement of the reliability of the single-line bidirectional communication can both be achieved.

The terminal TM11 of the connector 59 that can be assigned for single-line bidirectional communication may also be used as a terminal on the host 50 side for high-speed serial communication for transmitting a request. The terminal TM1 of the connector 107 that can be assigned for single-line bidirectional communication may also be used as a terminal on each memory system 100 side for receiving a request. At this time, the first signal line for transmitting the request may be wired or connected between the host 50 and the plurality of memory systems 100-1 to 100-n.

Further, the device IDs of the host 50 and the memory systems 100-1 to 100-n may be dynamically allocated by the host 50 when each device is communicatively connected to a communication line SL #. At this time, the host 50 may allocate a device ID to each device according to a procedure similar to a dynamic host configuration protocol (DHCP).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system, comprising:
a connector including a terminal; and
a controller configured to perform a single-line bidirectional communication with a host via a signal line connected to the terminal, wherein
a format of a signal communicated via the single-line bidirectional communication includes:
a start pulse at a first level;
a stop pulse at a second level different from the first level;
a plurality of data pulses after the start pulse but before the stop pulse, each of the data pulses being at the second level and having a pulse width set according to a data value represented thereby; and
a plurality of division pulses dividing the plurality of data pulses, each of the division pulses being at the first level and having a uniform pulse width,
a pulse width of the start pulse is greater than the uniform pulse width of the divisional pulses, and
a pulse width of the stop pulse is greater than any pulse width of the data pulses.

2. The memory system according to claim 1, wherein each data pulse is immediately followed by a division pulse.

3. The memory system according to claim 1, wherein the data value is a binary value.

4. The memory system according to claim 1, wherein the controller is configured to perform transmission of the start pulse of a first signal if the signal line stays at the second level for a time period at least equal to the pulse width of the stop pulse.

5. The memory system according to claim 4, wherein the controller is configured to perform re-transmission of the start pulse of the first signal, if the signal line does not shift to the second level after completing the transmission of the start pulse of a first signal.

6. The memory system according to claim 4, wherein the controller is configured to postpone the transmission of the start pulse of the first signal if the signal line shifts to the first level before starting the transmission.

7. The memory system according to claim 6, wherein the controller is configured to postpone the transmission of the start pulse of the first signal until the signal line stays at the second level for the time period at least equal to the pulse width of the stop pulse again.

8. The memory system according to claim 1, wherein the plurality of data pulses in the signal represents 8-bit data.

9. The memory system according to claim 1, wherein the plurality of data pulses in the signal represents an identification of a sender and communication data including a command or a notification.

10. The memory system according to claim 1, wherein
the signal line is connectable to the host and another memory system, and
the controller is further configured to perform the single-line bidirectional communication with another memory system via the signal line.

11. An information processing system, comprising:
a host; and
first and second memory systems, wherein
the host comprises:
a first terminal connected to a terminal of the first memory system;
a second terminal connected to a terminal of the second memory system; and
a host controller configured to perform a single-line bidirectional communication with the first and second memory systems via a signal line connected to the first and second terminals, wherein
a format of a signal communicated via the single-line bidirectional communication includes:
a start pulse at a first level;
a stop pulse at a second level different from the first level;
a plurality of data pulses after the start pulse but before the stop pulse, each of the data pulses being at the second level and having a pulse width set according to a data value represented thereby; and
a plurality of division pulses dividing the plurality of data pulses, each of the division pulses being at the first level and having a uniform pulse width,
a pulse width of the start pulse is greater than the uniform pulse width of the divisional pulses, and
a pulse width of the stop pulse is greater than any pulse width of the data pulses.

12. The information processing system according to claim 11, wherein the host controller is configured to perform transmission of the start pulse of a first signal after the signal line stays at the second level for a first predetermined time period at least equal to the pulse width of the stop pulse.

13. The information processing system according to claim 12, wherein
the first memory system includes a first memory controller configured to perform the single-line bidirectional communication with the host via the signal line, and
during the single-line bidirectional communication, the first memory controller is configured to perform transmission of a start pulse of a second signal after the signal line stays at the second level for a second predetermined time period at least equal to the pulse width of the stop pulse, the second predetermined time period being different from the first predetermined time period.

14. The information processing system according to claim 13, wherein
the second memory system includes a second memory controller configured to perform the single-line bidirectional communication with the host via the signal line, and
during the single-line bidirectional communication, the second memory controller is configured to perform transmission of a start pulse of a third signal after the signal line stays at the second level for a third predetermined time period at least equal to the pulse width of the stop pulse, the third predetermined time period being different from the first and second predetermined time periods.

15. The information processing system according to claim 14, wherein the second predetermined time period is longer than the first predetermined time period, and the third predetermined time period is longer than the second predetermined time period.

16. The information processing system according to claim 11, wherein the host controller is configured to:
detect a user operation to turn off the host;
broadcast a first signal to the first and second memory systems using the single-line bidirectional communication, if the detected user operation continues for a first length of time; and
broadcast a second signal to the first and second memory systems using the single-line bidirectional communication, if the detected user operation continues for a second length of time longer than the first length of time.

17. The information processing system according to claim 16, wherein
the first memory system is configured to perform a data non-volatilization operation upon receiving the second signal, and transmit a third signal upon completing the data non-volatilization operation using the single-line bidirectional communication,
the second memory system is configured to perform a data non-volatilization operation upon receiving the second signal, and transmit a fourth signal upon completing the data non-volatilization operation using the single-line bidirectional communication, and
the host controller is configured to terminate power supply to the first and second memory systems, after reception of both of the third and fourth signals.

18. The information processing system according to claim 17, wherein the host controller is configured to broadcast a fifth signal to the first and second memory systems using the single-line bidirectional communication, the fifth signal to cause the first and second memory systems to be turned on.

19. The information processing system according to claim 17, wherein the host controller is configured to broadcast a sixth signal to the first and second memory systems using the single-line bidirectional communication, the sixth signal to request a status of the first and second memory systems.

20. A method for performing a single-line bidirectional communication between a memory system and a host, the method comprising:
transmitting a first signal from the host to the memory system via a signal line connected between the memory system and the host; and
transmitting a second signal from the memory system to the host via the signal line after the memory system receives the first signal, wherein
each of the first and second signals includes:
a start pulse at a first level;
a stop pulse at a second level different from the first level;
a plurality of data pulses after the start pulse but before the stop pulse, each of the data pulses being at the second level and having a pulse width set according to a data value represented thereby; and
a plurality of division pulses dividing the plurality of data pulses, each of the division pulses being at the first level and having a uniform pulse width,
a pulse width of the start pulse is greater than the uniform pulse width of the divisional pulses, and
a pulse width of the stop pulse is greater than any pulse width of the data pulses.
